(19) United States
(12) Patent Application Publication
(10) Pub. No.: US 2015/0063872 A1
(43) Pub. Date: Mar. 5, 2015

(54) IMAGE FORMING APPARATUS

(71) Applicant: Samsung Electronics Co., Ltd., Suwon-si (KR)

(72) Inventors: Young-soo KO, Seoul (KR); Kwang-hyuck SO, Seoul (KR)

(73) Assignee: Samsung Electronics Co., Ltd., Suwon-si (KR)

(21) Appl. No.: 14/197,650

(22) Filed: Mar. 5, 2014

(30) Foreign Application Priority Data
Sep. 2, 2013 (KR) 10-2013-0104823
Oct. 31, 2013 (KR) 10-2013-0130976

(51) Int. Cl. G03G 15/08

(52) U.S. Cl. CPC G03G 15/0865
USPC 399/258

(57) ABSTRACT

An image forming apparatus, toner container, and method are provided. The image forming apparatus includes a main body, and a toner container configured to be installed in the main body. The toner container is installed in a toner container installing groove that is formed in an upper housing part of the main body.

### CROSS-REFERENCE TO RELATED APPLICATIONS

This application is related to, and claims priority benefit of Korean Patent Application No. 10-2013-0104823, filed on Sep. 2, 2013, and Korean Patent Application No. 10-2013-0130976, filed on Oct. 31, 2013, in the Korean Intellectual Property Office, the disclosures of which are incorporated herein by reference in its entirety.

### BACKGROUND

1. Field

The following description relates to an image forming apparatus, a toner container, and a method, and more particularly, to an image forming apparatus to which a toner container is applied.

2. Description of the Related Art

To perform printing on a paper sheet, a transfer method of scanning a laser beam onto an image receptor (for example, a photosensitive drum) may be applied to form an electrostatic latent image, developing the electrostatic latent image as a toner image, and transferring the toner image onto a printing sheet directly or by using a transfer belt.

In an image forming apparatus, such as a laser printer using this printing method, a toner supply unit that supplies toner to a main body of the image forming apparatus is generally installed in a consumable form to be replaceable.

To install the toner supply unit in the main body, a part of an external housing of the main body of the image forming apparatus may need to be opened. Therefore, it may be difficult to check whether the toner supply unit is installed without opening the external housing. Since opening and closing of the external housing may be required replacement of the toner supply unit may be inconvenient.

### SUMMARY

Exemplary embodiments may address at least the above problems and/or disadvantages and other disadvantages not described above. However, the exemplary embodiments are not required to overcome the disadvantages described above, and an exemplary embodiment may not overcome any of the problems described above.

An exemplary embodiment provides an image forming apparatus that facilitates easily checking whether a toner supply unit is installed, and conveniently performing work associated with replacement of the toner supply unit.

According to an aspect of an exemplary embodiment, an image forming apparatus is provided including a main body, and at least one toner container configured to be installed in the main body. The toner container may have a bottle shape. The toner container may be installed in a toner container installing groove. The toner container installing groove may be formed to be concave from an upper housing part of the main body.

The toner container may be installed in the toner container installing groove so as to expose at least a portion thereof outside the main body.

The toner container installing groove may vertically extend from the upper housing part downwards.

The upper housing part of the main body may include a toner container installing part having the toner container installing groove. The toner container installing part may include a lower part configured to have at least one toner discharge hole, and a vertical extending part configured to vertically extend from the lower part toward the upper housing part of the main body.

The toner container may include a container body configured to include at least one toner discharge hole that is formed in the container body, and a shutter member configured to be installed in the container body so as to be arranged in a first position for closing the toner discharge hole or in a second position for opening the toner discharge hole.

The shutter member may slide between the first and second positions in the container body.

The toner container may include an elastic pressurizing member that elastically pressurizes the shutter member into the first position. A lower part of the toner container installing part may include a pressurizing protrusion that pressurizes the shutter member into the second position when installing the toner container.

The shutter member may include a shutter part configured to have a disc shape and close the toner discharge hole when the shutter member is arranged in the first position, a support part configured to protrude from an upper surface of the shutter part and support the elastic pressurizing member, and a pressurized part configured to protrude from a lower surface of the shutter part and pressurize the pressurizing protrusion when installing the toner container.

The container body may be installed in the toner container installing part to bilaterally rotate within a preset angle range. An arrangement of the shutter member may be changed from the first position into the second position by a forward rotation of the container body or may be changed from the second position into the first position by a backward rotation of the container body.

At least one toner discharge hole may be formed in a lower part of the container body. At least one shutter hole may be formed in the shutter member and may be arranged to correspond to the at least one toner discharge hole in the second position.

At least one fixing protrusion may be formed at the toner container installing part to fix the shutter member, and at least one fixing groove may be formed in a lower part of the shutter member so as to insert the fixing protrusion thereinto.

The fixing protrusion may be elastically supported upwards by an elastic support member that is formed in the toner container installing part.

A screw protrusion may be formed at the lower surface of the container body, and a screw hole may be formed in the shutter member to be screwed to the screw protrusion.

At least one rotation protrusion may be formed at a side part of the container body, and at least one rotation guide groove may be formed in an inner surface of the toner container installing part to guide a rotation of the rotation protrusion.

At least one vertical guide groove may be formed in an inner surface of the vertical extending part to guide the rotation protrusion from the upper housing part to the rotation guide groove when installing the toner container.

The image forming apparatus may include a single toner container.

A toner amount display unit may be installed in the upper housing unit of the main body to display a residual amount of toner in the toner container in an analog way and may be arranged parallel with the toner container.

According to an exemplary embodiment, a toner container for an image forming apparatus having a housing part is provided, the toner container including at least one toner discharge hole capable of being opened upon installing the toner container in the image forming apparatus, a shutter member for opening and closing the toner discharge hole, and a pressurizing protrusion part for pressurizing the toner container.

The toner container may be color-coded to identify a color of toner contained in the toner container.

According to an exemplary embodiment, a method for installing a toner container in an image forming apparatus is provided including inserting the toner container in the image forming apparatus, and rotating the toner container to open a toner discharge hole.

The method may include rotating the toner container pressurizing a shutter member of the toner container.

### BRIEF DESCRIPTION OF THE DRAWINGS

The above and/or other aspects will be more apparent by describing certain exemplary embodiments with reference to the accompanying drawings, in which:

FIG. 1 is a perspective view of an image forming apparatus according to an exemplary embodiment;

FIG. 2 is a perspective view illustrating an exemplary image forming apparatus from which a toner container is separated;

FIG. 3 is an exemplary cross-sectional view taken along line I-I of FIG. 1;

FIG. 4 is an exploded perspective view of an exemplary toner container installed in an image forming apparatus;

FIG. 5 is a perspective view of an exemplary container installing part of an image forming apparatus;

FIGS. 6A and 6B are views illustrating a process of inserting a toner container into a toner container installing part, according to an exemplary embodiment;

FIG. 7 is a perspective view of an exemplary alternative toner container that is installable in a main body of an image forming apparatus;

FIG. 8 is an exploded perspective view of an exemplary alternative toner container;

FIG. 9 is a plan view illustrating an exemplary part around a toner container installing groove of a main body of an image forming apparatus in which the toner container is installed;

FIG. 10 is a partial cross-sectional view of an image forming apparatus in which an exemplary toner container is installed;

FIG. 11 is a partial cross-sectional view illustrating an alternative arrangement of an exemplary shutter member;

FIG. 12A is a cross-sectional view taken along line II-II of FIG. 10 to illustrate an exemplary completed state of an operation of inserting a toner container in a process of installing the toner container in a main body of an image forming apparatus;

FIG. 12B is a cross-sectional view taken along line II-II of FIG. 10 to illustrate a completed state of an operation of rotating a toner container in a process of installing the toner container in the main body of a image forming apparatus;

FIG. 13 is a cross-sectional view illustrating the toner container of FIG. 7, according to another exemplary embodiment of the present general inventive concept;

FIG. 14 is a perspective view of an image forming apparatus according to an exemplary embodiment;

FIG. 15 is a perspective view illustrating an exemplary image forming apparatus o from which toner containers are separated;

FIG. 16A is an exemplary cross-sectional view taken along line III-Ill of FIG. 14; and

FIG. 16B is an exemplary cross-sectional view taken along line IV-IV of FIG. 14.

### DETAILED DESCRIPTION

Exemplary embodiments are described in greater detail with reference to the accompanying drawings.

In the following description, the same drawing reference numerals are used for the same elements in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail because they would obscure the description of exemplary embodiments with unnecessary detail.

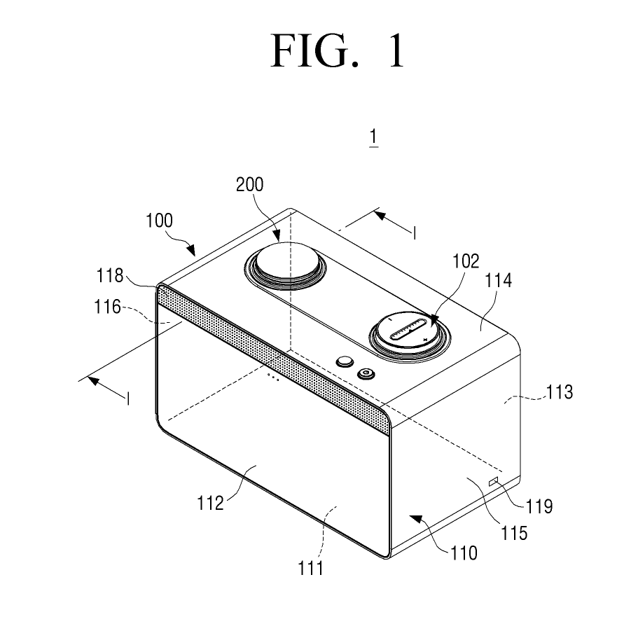

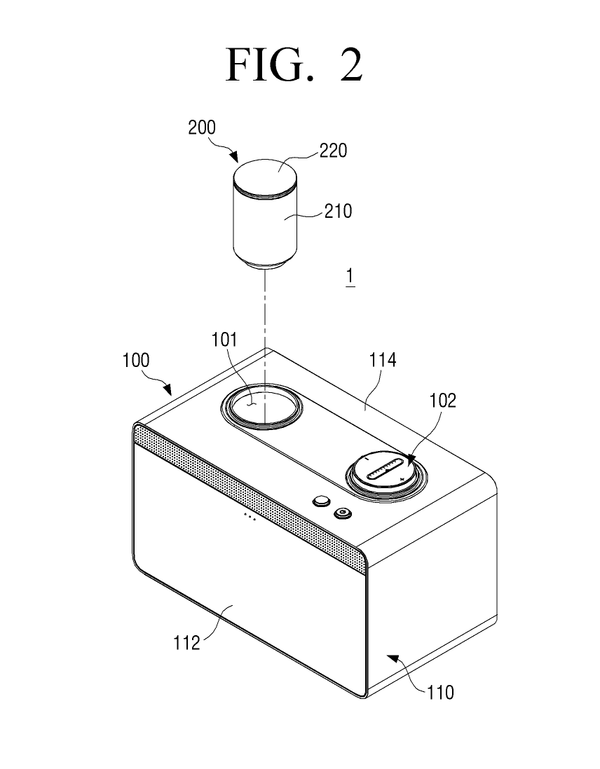

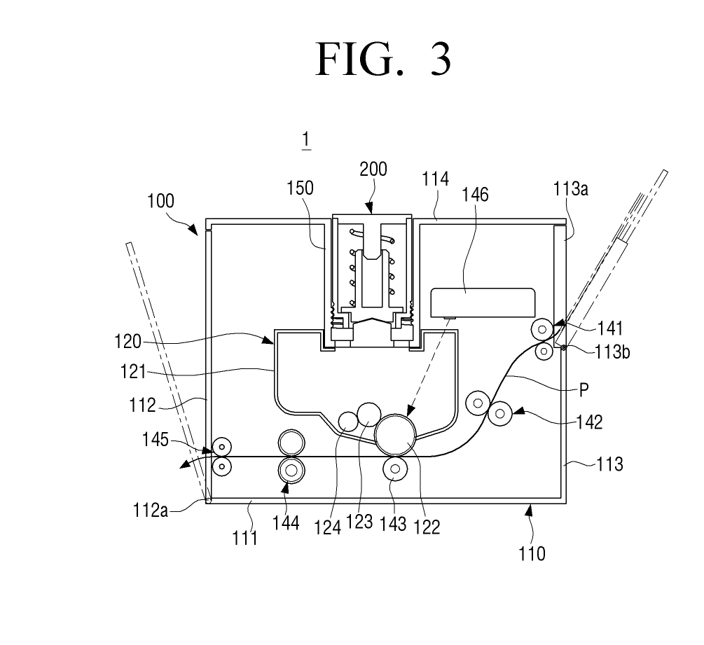

FIG. 1 is a perspective view of an image forming apparatus 1 according to an exemplary embodiment. FIG. 2 is an exemplary perspective view of an image forming apparatus 1 from which a toner container may be separated. FIG. 3 is an exemplary cross-sectional view taken along line I-I of FIG. 1.

As illustrated in FIGS. 1 through 3, the image forming apparatus 1 may be a monochrome laser printer having a small size and includes a main body 100. A toner container 200 may be detachably installed in, or to, the main body 200.

The main body 100 includes an external housing 110 that houses a plurality of internal parts and forms an external appearance of the image forming apparatus 1. The external housing 110 lower and upper housing parts 111 and 114 may face each other to form upper and lower surfaces of the image forming apparatus 1, front and back housing parts 112 and 113 may face each other to form front and back surfaces of the image forming apparatus 1, and right and left housing parts 115 and 116 may face each other to form right and left surfaces of the image forming apparatus 1. The main body 100 of the image forming apparatus 1 may have, for example, a simple rectangular parallelepiped external appearance.

As illustrated in FIG. 1, an acoustic emission part 118 having acoustic emission holes may be formed in the front housing part 112. The main body 100 may include a speaker unit (not illustrated) that provides a sound such as a notification sound, music, or the like through the acoustic emission part 118. As illustrated in FIG. 1, the right housing part 115 includes a universal serial bus (USB) port 119. The USB port 119 may be included in the left housing part 116 and/or the back housing part 113. If an external apparatus such as a smartphone, a personal computer (PC), or the like, is connected to the USB port 119 through an USB cable, the image forming apparatus 1 may operate as a printer that outputs image data provided by the external apparatus connected to the USB port 119 and/or operate as a speaker that outputs acoustic data provided by the external apparatus.

As illustrated in FIG. 3, a paper inserting door 113a for insertion of a paper sheet into the main body 100 may be included in the back housing part 113. The paper inserting door 113a may be pivotably combined with the back housing par 113 with a hinge 113b. When performing a printing job, a user opens the paper inserting door 113a to lean the paper inserting door 113a against the back housing part 113 in order to supply paper sheets into the main body 100.

As illustrated in FIG. 3, the front housing part 112 may be pivotably combined with the lower housing part 111 through a hinge 112a. Therefore, when performing the printing job, the front housing part 112 may be opened by the user, for example, to be parallel with the lower housing part 111. Therefore, paper sheets on which the printing job has been completed may be sequentially loaded on the front housing part 112 that is opened to be parallel with the lower housing part 111.

As illustrated in FIG. 2, a toner amount display unit 102 may be installed on the upper housing part 114 to display a residual amount of toner in the toner container 200, for example, with an analog display. The toner amount display unit 102 may be parallel with the toner container 100 and a distance from the toner container 200. According to an exemplary embodiment, display scales of the toner amount display unit 102 may be arranged vertically. Alternatively, the display scales of the toner amount display unit 102 may be arranged in a circular shape, e.g., similar to a speedometer display in a car. The user may view the toner display unit 102 to easily check the residual amount of toner in the toner container 200 without, for example, a computer monitor connected to the image forming apparatus 1.

An exemplary toner container 200 is illustrated in FIGS. 1 and 2. The toner container may include feeding entrances formed on the top and housing spaces connected to the feeding entrances, and may be a bottle shape. The toner container 200 may have a circular cross-section according to an exemplary embodiment. Alternatively, the toner container 200 may have various cross-section shapes such as a elliptical cross-section, a rectangular cross-section, etc.

The toner container 200 contains, for example, monochrome toner (for example, black toner). A toner container installing groove 101 may be formed in the main body 100, for example, to be concave from the upper housing part 114. The toner container 200 may be installed in the toner container installing groove 101 to supply toner contained in the toner container 200 into the main body 100.

Alternatively, the toner container installing groove 101 may be formed in a side of the main body 100 such as the left housing part 115 or the right housing part 116. According to an exemplary embodiment, the toner container installing groove 101 may be formed in the upper housing part 114 of the main body 100 to allow the user to easily install the toner container 200 into the toner container installing groove 101.

The toner container installing groove 101 vertically extends from the upper housing 114 downwards. Therefore, the toner container 200 installed in the toner container installing groove 101 is vertically arranged, and thus the toner contained in the toner container 200 may be smoothly discharged outside the toner container 200 with assistance of gravity. Since the toner container installing groove 101 may not be covered with an external casing 110 and be exposed to the outside, additional work for opening the external casing 110 is not needed when replacing the toner container 200. Therefore, work related to replacement work of the toner container 200 may be easily performed.

Only one toner container 200 is illustrated in FIGS. 1 and 2, but another, for example, longer toner container (not illustrated) may be further used. In other words, a plurality of toner containers having same or different capacities may be installed in the main body 100. Since the toner container 200 may be installed in the main body 100 to expose at least an upper part thereof to the outside, the user may check which type of toner container is installed in the main body 100 without viewing an interior of the main body 100.

As illustrated in FIG. 3, the main body 110 houses parts such as a developer unit 120, a pickup unit 141, one or more transfer units 142, a transfer roller 143, a fixing unit 144, a paper discharge unit 145, a exposure unit 146, etc. The developer unit 120 includes a developer unit casing 121. A photosensitive drum 122, a developer roller 123, and a supply roller 124 may be housed in the developer unit casing 121.

A printing process of the image forming apparatus 1 according to a paper path P is described. When a printing job starts, an electrostatic latent image reflecting printing data may be formed on the photosensitive drum 122 through a laser provided by the exposure unit 146 and developed as a toner image by the developer roller 124. A printing paper sheet may be picked up by the pickup unit 141 and passes through the photosensitive drum 122 and the transfer roller 143 so as to transfer the toner image formed on the photosensitive drum 122 onto the printing paper sheet. Thereafter, the printing paper sheet undergoes an image fixing process performed by the fixing unit 144 and is discharged outside the main body 100 by the paper discharge unit 145.

As illustrated in FIG. 3, the toner container installing part 150 having the toner container installing groove 101, illustrated in FIG. 2, may be installed in the upper housing part 114 of the main body 100. The toner container installing part 150 vertically extends from the upper housing part 144 into the main body 100 and may be connected to the developer unit casing 121. Therefore, when the toner container 200 is completely installed in the toner container installing part 150, toner discharged from the toner container 200 may be supplied into the developer unit 120 through the toner container installing part 150. According to an exemplary embodiment, the toner container installing part 150 may form a part of the upper housing part 114. Alternatively, the toner container installing part 150 may form a part of the developer unit casing 121.

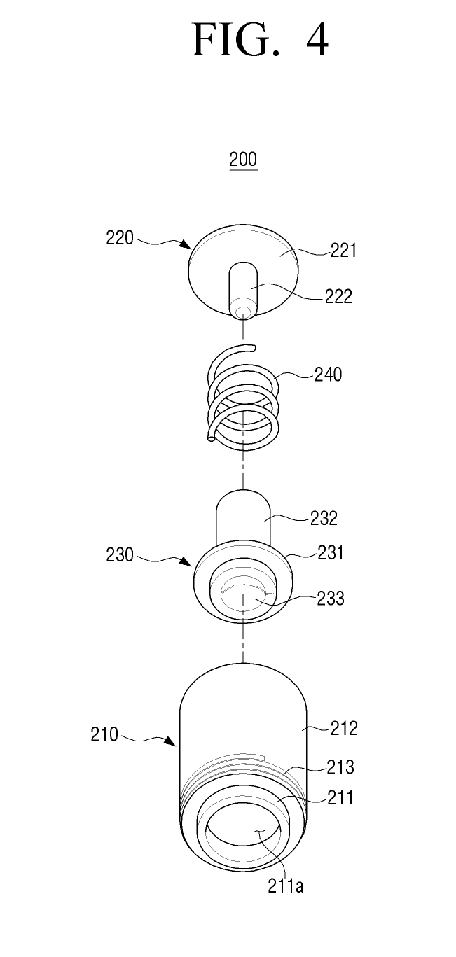

The toner container 200 and the toner container installing part 150 are described in detail with reference to FIGS. 4, 5, 6A, and 6B.

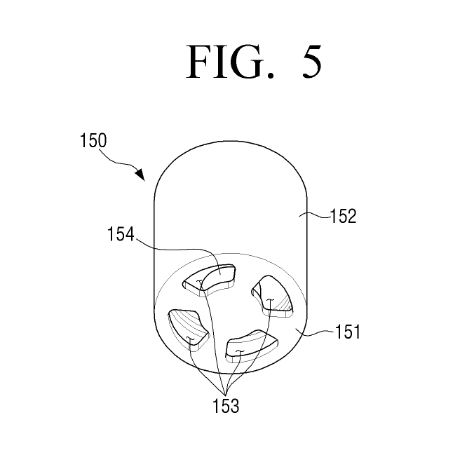

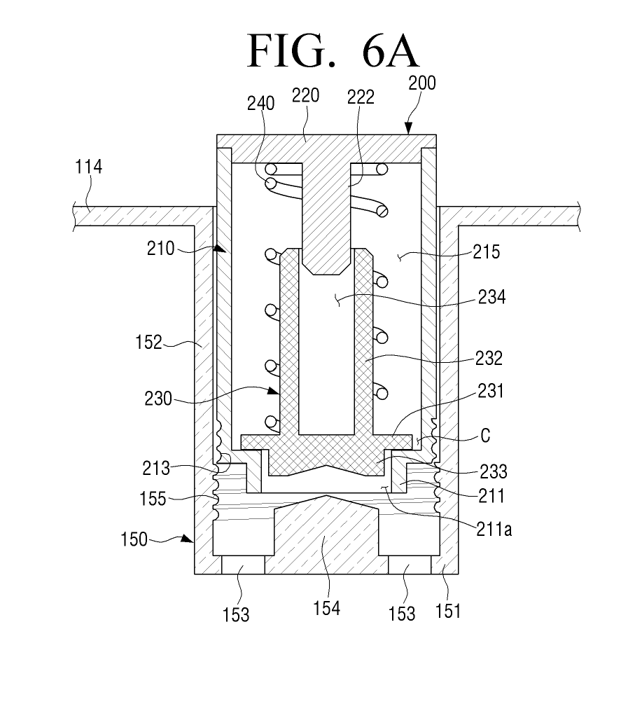

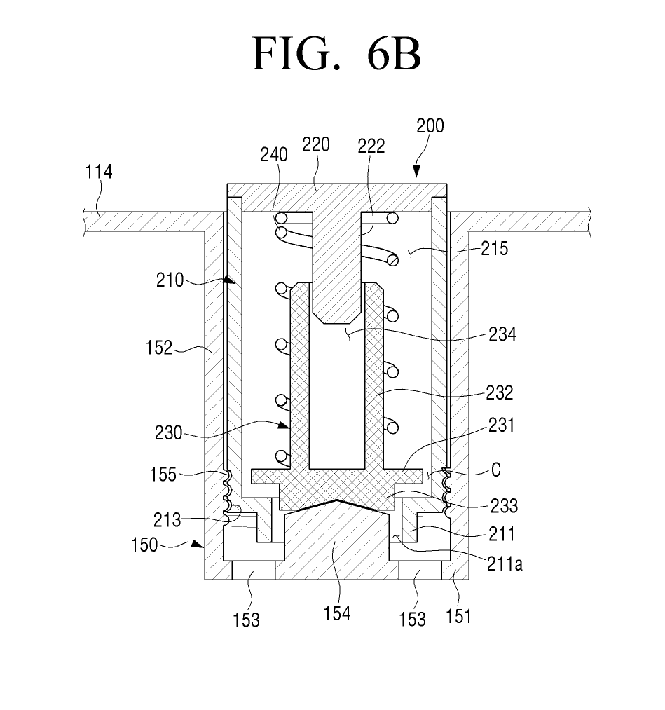

FIG. 4 is an exploded perspective view of a toner container 200 installed in the image forming apparatus 1. FIG. 5 is a perspective view of a toner container installing part 150 installed in the image forming apparatus 1. FIGS. 6A and 6B are views illustrating a process of installing the toner container 200 in the toner container installing part 150.

As illustrated in FIGS. 4 and 6A, the toner container 200 includes a container body 210, a cap member 220, a shutter member 230, and a elastic pressurizing unit 240.

The container body 210 has an approximately cylindrical shape and includes a toner containing space 215. A toner discharge hole 211a is formed in a lower part 211 of the container body 210. A screw thread 213, for example female screw thread may be formed in a particular width on a side part 212 of the container body 210.

The cap member 220 may be combined with an upper part of the container body 210 to prevent toner contained in the toner container 200 from being discharged up the toner container 200. The cap member 220 includes a cap part 221 that closes the upper part of the container body 210 and a shutter guide protrusion 222 that protrudes from a lower surface of the cap part 221.

The shutter member 230 includes a shutter part 231, which may have a disc shape, an elastic member support part 232 that protrudes from an upper surface of the shutter part 231, and a pressurized part 233 that protrudes from a lower surface of the shutter part 231.

The shutter part 231 opens and closes the toner discharge hole 211a that is formed in the container body 210. As illustrated in FIG. 6A, a diameter of the shutter part 231 is smaller than an internal diameter of the container body 210. Therefore, a path C that is used to move toner is formed between the shutter part 231 and the container body 210.

The elastic member support part 231 is inserted into the elastic pressurizing member 240 to support the elastic pressurizing member 240 so that the elastic pressurizing member 240 maintains a position thereof between the cap part 221 and the shutter part 231. A shutter guide hole 234 into which the shutter guide protrusion 222 of the cap member 220 is inserted may be formed in the elastic member support part 232. The shutter guide protrusion 222 may be inserted into the shutter guide hole 234 to accurately perform upward and downward movements of the shutter member 230.

The pressurized part 233 may be pressurized by a pressurizing protrusion 154 of the toner container installing part 150 of FIG. 6A when the toner container 200 is installed in the toner container installing part 150.

The elastic pressurizing member 240 elastically pressurizes the shutter member 230 downwards. According to an exemplary embodiment, the elastic pressurizing member 240 is included as a coil spring that is disposed between the cap part 221 and the shutter member 230 of the cap member 220. The elastic pressurizing member 240 may be supported by the elastic member support part 232 of the shutter member 230.

As illustrated in FIGS. 5 and 6A, the toner container installing part 150 includes a lower part 151 in which a plurality of toner discharge holes 153 may be formed and a vertical extending part 152 that vertically extends toward the upper housing part 114 of the main body 100 of the image forming apparatus 1.

According to an exemplary embodiment, a plurality of toner discharge holes 153, e.g., four toner discharge holes may be formed in the lower part 151. The number of toner discharge holes 153 may be variously changed according to exemplary embodiments. The pressurizing protrusion 154 may be formed on an inner surface of the lower part 151. When the toner container 200 is installed in the main body 100, the shutter member 230 is pressurized upwards by the pressurizing protrusion 154 to open the toner discharge hole 211 of the toner container 200. A male screw thread 155 corresponding to the female screw thread 213 is formed in a particular width on an inner surface of the vertical extending part 152.

An exemplary process of installing the toner container 200 includes a first operation of inserting the toner container 200 into the toner container installing part 150 of the main body 100, and a second operation of rotating the toner container 200 to open the toner discharge hole 211a.

FIG. 6A illustrates the toner container 200 and the toner container installing part 150 after the first operation (the toner inserting operation) is completed. FIG. 6B illustrates the toner container 200 and the toner container installing part 150 after the second operation (the toner container rotating operation) is completed.

As illustrated in FIG. 6A, after the first operation (the toner container inserting operation) is performed, the shutter member 230 maintains a first position (a closed position) for closing the toner discharge hole 211a, by an elastic force provided by the elastic pressurizing member 240. The pressurizing protrusion 154 of the toner container installing part 150 does not contact the shutter member 230. After the first operation (the toner container inserting operation) is performed, the toner discharge hole 221a is kept closed, and thus toner is not discharged from the toner container 200.

As illustrated in FIG. 6B, as the toner container 220 is rotated in a first direction (in a forward direction) in the second operation (the toner container rotating operation), the female screw thread 213 of the toner container 200 interacts with the male screw thread 155 of the toner container installing part 150 to position the toner container 200 a little more downwards. In the second operation, the shutter member 230 is pressurized by the pressurizing protrusion 154 of the toner container installing part 150 to be disposed in a second position (an opened position) for opening the toner discharge hole 211a of the container body 210. Therefore, when the second operation (the toner container rotating operation) is completed, the toner discharge hole 211a of the toner container 200 is kept open, for example, as illustrated in FIG. 6B. As a result, the toner contained in the toner container 200 may be supplied into the developer unit 120 through the toner discharge hole 211a of the toner container 200 and the toner discharge hole 153 of the toner container installing part 150.

A process of separating the toner container 200 from the main body 100 may be performed directly opposite to the process of installing the toner container 200. The toner container 200 may be rotated in a second direction (in a backward direction) to release an interaction between the screw threads 213 and 155 and pressurization of the pressurizing protrusion 154 onto the shutter member 230. As illustrated in FIG. 6A, since the pressurizing of the pressurizing protrusion 154 is released, the shutter member 230 returns into a first position in which the toner discharge hole 211a is closed by an elastic force of the elastic pressurizing member 240. The toner container 200 may be removed from the toner container installing part 150 to complete the process of separating the toner container 200.

The toner discharge hole 211a is closed by the shutter member 230, and the toner container 200 may be separated from the toner container installing part 150. Therefore, when performing work related to a replacement of the toner container 200, the main body 100 and/or the user may be prevented from being soiled by residual toner in the toner container 200.

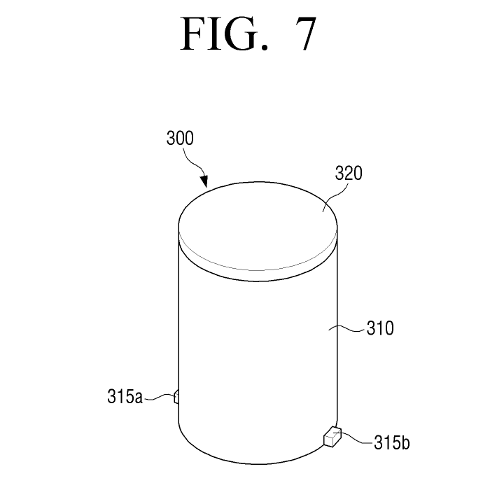

An alternative toner container 300 may be installed in the main body 100. The stoner container 300 is described with reference to FIGS. 7 through 11, 12A, and 12B.

FIGS. 7 through 11 are first referred to.

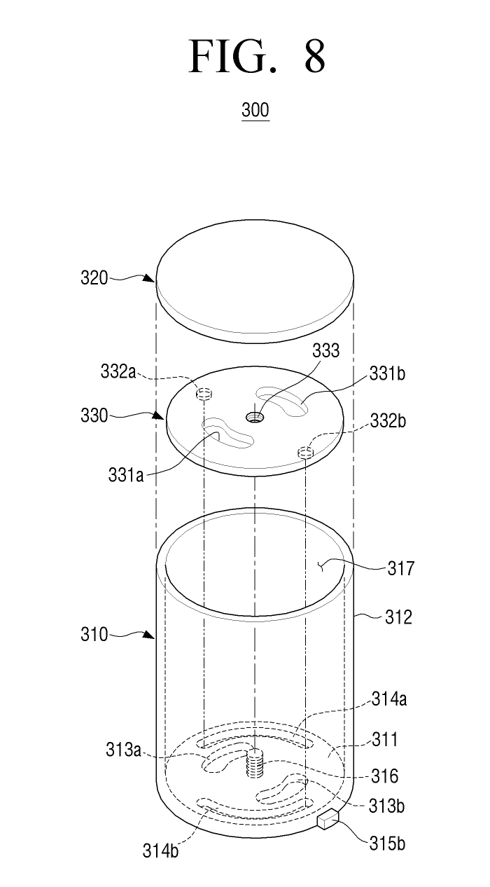

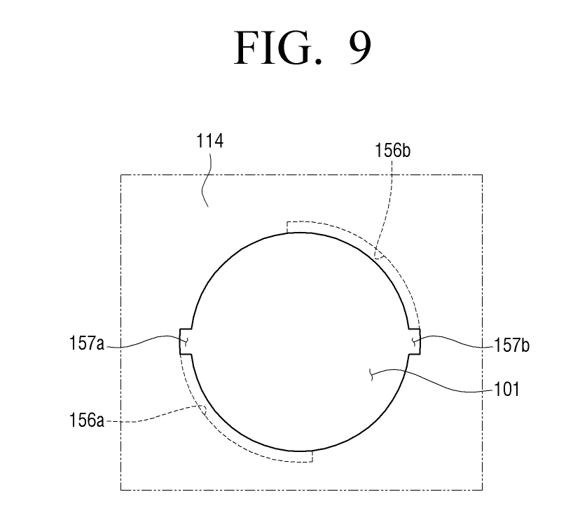

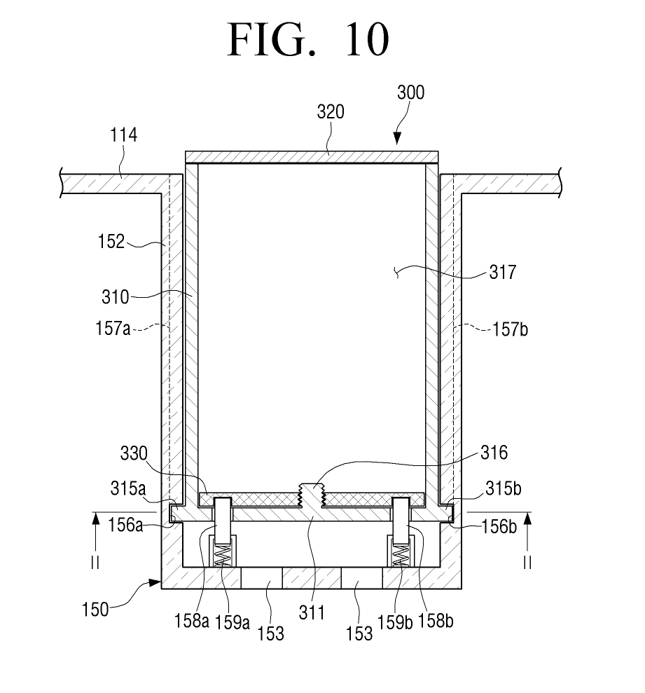

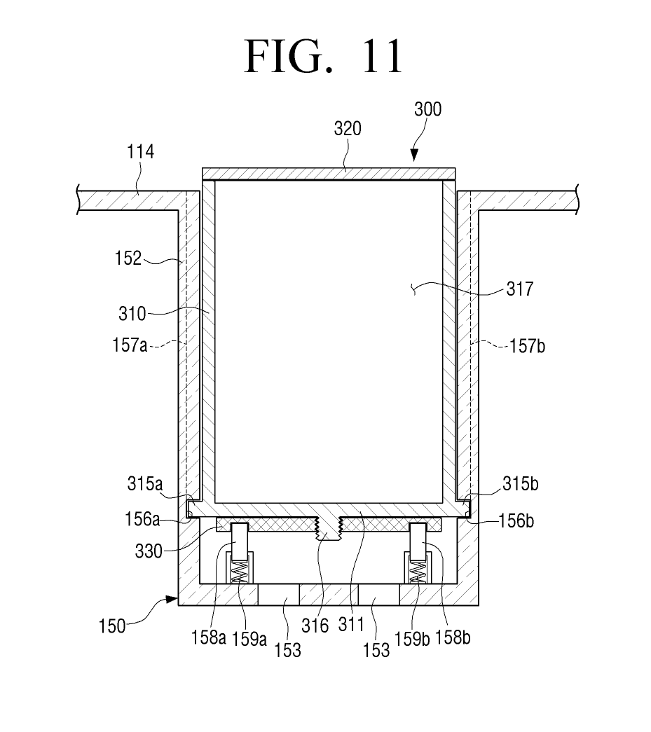

FIG. 7 is a perspective view of the alternative toner container 300 that may be installed in the main body 100 of an image forming apparatus 1. FIG. 8 is an exemplary exploded perspective view of the toner container 300 of FIG. 7. FIG. 9 is an exemplary plan view illustrating a part around a toner container installing groove of the main body 100 of the image forming apparatus 1 in which the toner container 300 of FIG. 7 is installed. FIG. 10 is an exemplary cross-sectional view of the image forming apparatus 1 in which the toner container 300 of FIG. 7 is installed. FIG. 11 is an exemplary cross-sectional view illustrating an alternative arrangement of a shutter member 330.

The toner container 300 includes a container body 310 that has a cylindrical shape and includes a toner containing space 317, a cap member 320 that may be combined with an upper end of the container body 310, and a shutter member 330 that may be combined with a lower part 311 of the container body 310.

The container body 310 includes a lower surface 311 that has a disc shape and a side part 312 that vertically extends from an edge of the lower surface 311 upwards. A screw protrusion 316 may be formed in a center of the lower surface 311 to protrude upwards. First and second toner discharge holes 313a and 313b and first and second fixed protrusion through-holes 314a and 314b may be formed in the lower surface 311. First and second rotation protrusions 315a and 315b may be formed at an uppermost end of the side part 312. According to an exemplary embodiment, two rotation protrusions 315a and 315b are included. Alternatively, according to exemplary embodiments, the number of rotation protrusions may be changed, for example, to one, three, or the like.

As illustrated in FIGS. 9 and 10, first and second rotation guide grooves 156a and 156b that guide rotations of the first and second rotation protrusions 315a and 315b may be formed on an inner surface of the vertical extending part 152 of the toner container installing part 150. First and second vertical guide grooves 157a and 157b may be vertically formed on the inner surface of the vertical extending part 152 to guide the first and second rotation protrusions 315a and 315b to the first and second rotation guide grooves 156a and 156b when installing the toner container 300. In consideration of shapes of the first and second rotation guide grooves 156a and 156b illustrated in FIG. 9, rotation angle ranges of the first and second rotation protrusions 315a and 315b may be, for example, each 90°.

The cap member 320 may be combined with an upper end of the container body 310 to prevent toner contained in the toner container from being discharged upwards.

The shutter member 330 opens and closes the toner discharge holes 313a and 313b of the container body 310. Therefore, first and second shutter holes 331a and 331b that open and close the first and second discharge holes 313a and 313b may be formed in the shutter member 330. A screw hole 333, as illustrated in FIG. 8, for example, that interacts with the screw protrusion 316 of the container body 310 may be formed in a center of the shutter member 330. Fixing grooves 332a and 332b, for example, a pair of fixing grooves, may be formed in a lower surface of the shutter member 330. Fixing protrusions 158a and 158b, for example, a pair of fixing protrusions, (as illustrated, for example, in FIG. 10) that are elastically supported by elastic support parts 159a and 159b, for example, a pair of elastic support parts, may be installed at the lower part 151 of the toner container installing part 150. When installing the toner container 300, the fixing protrusions 158a and 158b may be inserted into the fixing grooves 332a and 332b of the shutter member 330 to fix the shutter member 300 so that the shutter member 330 is not rotated. In the illustrated exemplary embodiment, the number of fixing protrusions and the number of fixing grooves are respectively two, but the number may be changed, for example, to one, three, or the like.

The shutter member 330 may be screwed to the screw protrusion 316 of the container body 310 through the screw hole 333 to be installed on the lower surface 311 of the container body 310. Since the shutter member 330 may be screwed to the container body 310 by a screwing method, positions of the fixing grooves 332a and 332b of the shutter member 330 may be set to accurately correspond to positions of the fixing protrusions 158a and 158b of the toner container installing part 150 at a time when the shutter member 330 is completely installed. Therefore, when the toner container 300 is installed in the toner container installing part 150, the fixing protrusions 158a and 158b may be accurately inserted into the fixing grooves 332a and 332b of the shutter member 330, for example, as illustrated in FIG. 10.

If the screw hole 333 and the screw protrusion 316 are replaced with a non-threaded hole and protrusion, the fixing grooves 332a and 332b of the shutter member 330 may be arranged in arbitrary positions and not in fixed positions. Therefore, when installing the toner container 300, it may be difficult to accurately insert the fixing protrusions 158a and 158b into the fixing grooves 332a and 332b of the shutter member 330.

As illustrated in FIG. 10, the screw protrusion 316 may be formed on the inner surface of the lower surface 311 of the container body 310. The shutter member 330 may be arranged in the container body 310. Alternatively, as illustrated in FIG. 11, the screw protrusion 316 may be formed on an outer surface of the lower surface 311 of the container body 310. In this case, the shutter member 330 may be arranged outside the container body 310. The fixing protrusion through-holes 314a and 314b do not need to be formed in the lower surface 311 of the container body 310.

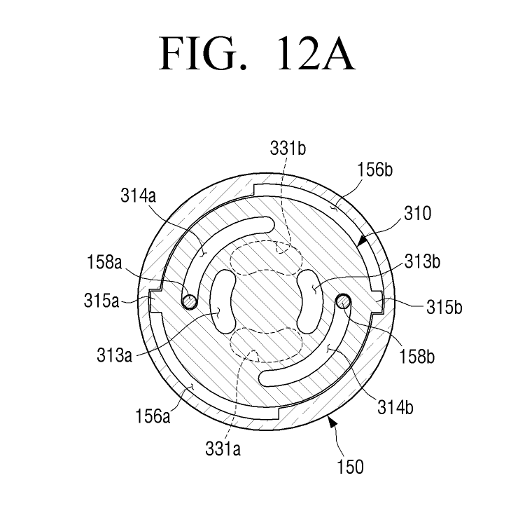

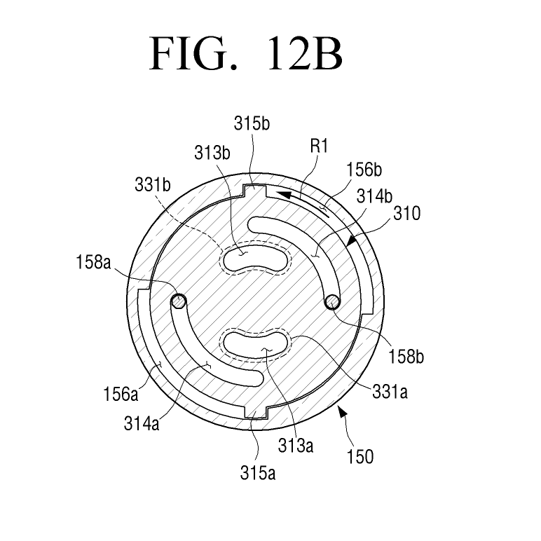

FIGS. 12A and 12B are described.

Installing of the toner container 300 may be performed by a first operation of inserting the toner container 300 into the toner container installing part 150 of the main body 100, and a second operation of rotating the toner container 300 to open the toner discharge holes 331a and 331b.

FIGS. 12A and 12B are cross-sectional views taken along line II-II of FIG. 10. FIG. 12A illustrates a completed state of a toner container inserting operation (the first operation) in a process of installing the toner container 300 of FIG. 7. FIG. 12B illustrates a completed state of a toner container rotating operation (the second operation) in the process of installing the toner container 300 of FIG. 7.

As illustrated in FIG. 12A, if the toner container inserting operation (the first operation) is completed, the first and second rotation protrusions 315a and 315b of the container body 310 are arranged in the first and second rotation guide grooves 156a and 156b of the toner container installing part 150. The fixing protrusions 158a and 158b of the toner container installing part 150 are inserted into the fixing grooves 332a and 332b (as illustrated, for example, in FIG. 8) of the shutter member 330 through the fixing protrusion through-holes 314a and 314b of the container body 310 to prevent the shutter member 330 from being rotated. The toner discharge holes 313a and 313b formed in the container body 310 are kept closed by the shutter member 330.

As illustrated in FIG. 12B, the toner container 310 may be 90° rotated, for example, in a counter-clockwise direction (in direction R1) in the toner container rotating operation (the second operation). If the second operation is completed, the first and second toner discharge holes 313a and 313b of the container body 310 are arranged in positions corresponding to positions of the first and second shutter holes 331a and 331b of the shutter member 330. Accordingly, the first and second toner discharge holes 313a and 313b of the container body 310 are opened by the shutter member 330. Therefore, after the second operation is completed, the toner contained in the toner container 300 may be discharged from the toner container 300 to be supplied into the developer unit 120.

Separating the toner container 200 from the main body 100 may be performed in an opposite manner to the work for installing the toner container 300. The toner container 300 may be rotated, for example, 90° in a clockwise direction, opposite to direction R1 illustrated in FIG. 12B to close the toner discharge holes 313a and 313b by the shutter member 330. Thereafter, the toner container 300 may be taken out of the toner container installing part 150 to complete the work for separating the toner container 300.

After the toner container holes 313a and 313b are closed by the shutter member 330, the toner container 300 may be separated from the toner container installing part 150. Therefore, when performing a replacement of the toner container 300, the main body 100 and/or the user may be prevented from being soiled by the residual toner in the toner container 300.

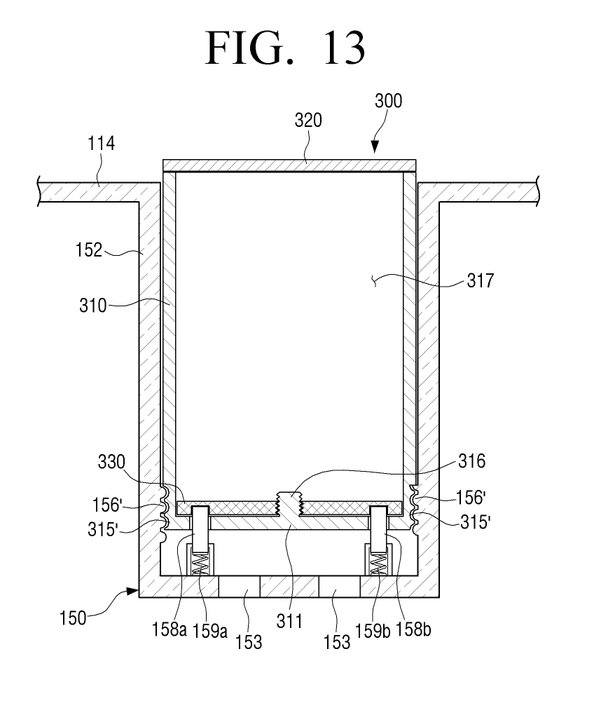

FIG. 13 is a cross-sectional view illustrating the toner container 300 of FIG. 7, according to an exemplary embodiment.

As illustrated in FIG. 13, a female screw thread 315′ may be formed at the toner container 300, and a male screw thread 156′ corresponding to the female screw thread 156′ may be formed at the toner container installing part 150. Therefore, when opening and closing the toner discharge holes 313a and 313b, rotation of the toner container 300 in the toner container installing part 150 may be achieved. According to the exemplary embodiment, the rotation protrusions 315a and 315b (as illustrated, for example, in FIG. 8), the rotation guide grooves 156a and 156b, and the vertical guide grooves 157a and 157b are not needed.

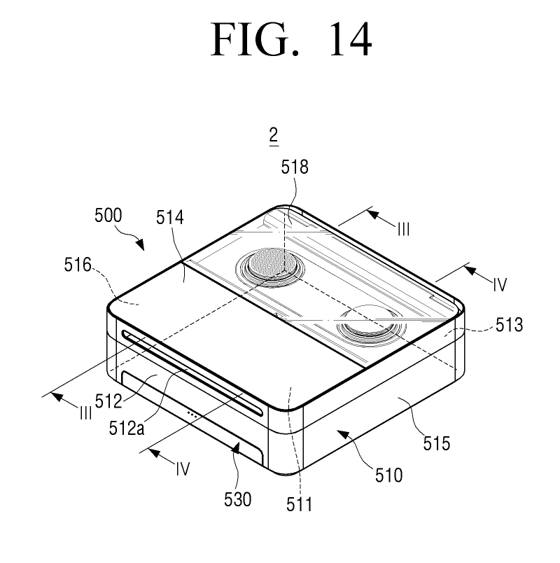

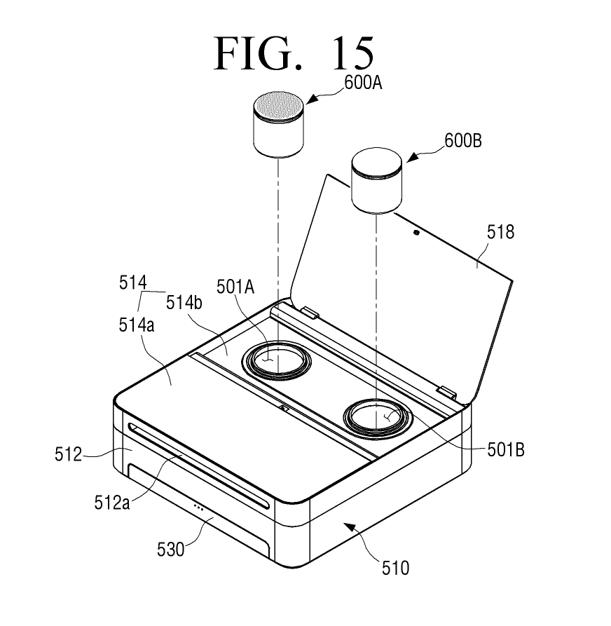

FIG. 14 is a perspective view of an image forming apparatus 2 according to an exemplary embodiment. FIG. 15 is an exemplary perspective view of the image forming apparatus 2 of FIG. 14 from which toner containers are separated.

As illustrated in FIGS. 14 and 15, the image forming apparatus 2 according to an exemplary embodiment is a two-color laser printer having a relatively small size and includes a main body 500 and two toner containers 600A and 600B that are detachably installed in the main body 500.

The main body 500 includes an external housing 510 that houses a plurality of internal parts to form an external appearance of the image forming apparatus 2. The external housing 510 includes lower and upper housing parts 511 and 514 that face each other to form lower and upper surfaces of the image forming apparatus 2, front and back housing parts 512 and 513 that face each other to form front and back surfaces of the image forming apparatus 2, and right and left housing parts 515 and 516 that face each other to form right and left surfaces of the image forming apparatus 2. The main body 500 has an approximately simple rectangular parallelepiped appearance formed by the external housing 510.

A paper discharge hole 512a that discharges a printed paper sheet may be formed in an upper end of the front housing part 512. A front end of a paper tray unit 530 is exposed in a lower end of the front housing part 512. A user may pull the paper tray unit 530 and supply paper sheets into the paper tray unit 530.

The upper housing part 514 includes a front area 514a that is arranged in front and a back area 514b that is arranged at the back. The front and back areas 514a and 514b may have a step difference so that the back area 514b is arranged slightly deeper than the front area 514a. Two toner container installing grooves 501A and 501B are formed in the back area 514b to be concave downwards. The external housing 510 includes a cover member 518 that may be formed of a transparent or semi-transparent material to open and close the back area 514b.

The two toner containers 600A and 600B may have cylindrical or bottle shapes. The two toner containers 600A and 600B may be respectively installed in the first and second toner container installing grooves 501A and 501B formed in the upper housing part 514. Therefore, toners contained in the toner containers 600A and 600B may be supplied in to the main body 500. As illustrated in FIG. 15, the first and second toner container installing grooves 501A and 501B are arranged in parallel and distanced from each other. Therefore, the first and second toner containers 600A and 600B installed in the first and second toner container installing grooves 501A and 501B are arranged in parallel and distanced from each other.

Alternatively, the toner container installing grooves 501A and 501B may be formed in a side part of the main body 500 such as the left housing part 515 or the right housing part 516. However, the toner container installing grooves 501A and 501B may be formed in the upper housing part 514 of the main body 500 according to an exemplary embodiment to allow the user to easily install the toner containers 600A and 600B in the toner container installing grooves 501A and 501B.

The toner container installing grooves 501A and 501B vertically extend from the upper housing part 514 downwards. Therefore, the toner containers 600A and 600B installed in the toner container installing grooves 501A and 501B are also vertically arranged to smoothly discharge the toners contained in the toner containers 600A and 600B outside the toner containers 600A and 600B with assistance of gravity.

Since the toner container installing grooves 501A and 501B are exposed to the outside only by opening of the cover member 518, accesses to the toner containers 600A and 600B may be easy so as to conveniently perform work for installing and separating the toner containers 600A and 600B.

The toner containers 600A and 600B are long enough to expose at least portions thereof outside the toner container installing grooves 501A and 501B when the toner containers 600A and 600B are installed in the toner container installing grooves 501A and 501B. A part of a toner container, e.g., upper ends (for example, cap parts) of the toner containers 600A and 600B may have the same colors as those of toner contained therein. Therefore, the user may easily check types of toner containers installed in the image forming apparatus 2.

The two toner containers 600A and 600B may contain different colors of toners. According to an exemplary embodiment, the first toner container 600A contains a black color of toner, and the second toner container 600B contains a highlight color of toner different from the black color of toner. For example, the second toner container 600B may contain a red color of toner used for highlighting. However, an exemplary embodiment is not limited thereto, and the second toner container 600B may contain a different color of toner (for example, blue color toner, green color toner, yellow color toner, or the like) that may be used for highlighting.

A basic color of toner, e.g., a black color of toner, and a red color of toner used for highlighting may be provided by the two toner containers 600A and 600B. Therefore, monochrome printing and monochrome printing to which highlighting is added may be performed by the image forming apparatus 2.

Each of the toner containers 600A and 600B may have a structure such as one of the first type of toner container 200 of FIG. 2 and the second type of toner container 300 of FIG. 7. Therefore, similar to the toner containers 200 and 300, when performing a replacement work for the toner containers 600A and 600B, the main body 500 or the user may be prevented from being soiled by residual toners in the toner containers 600A and 600B.

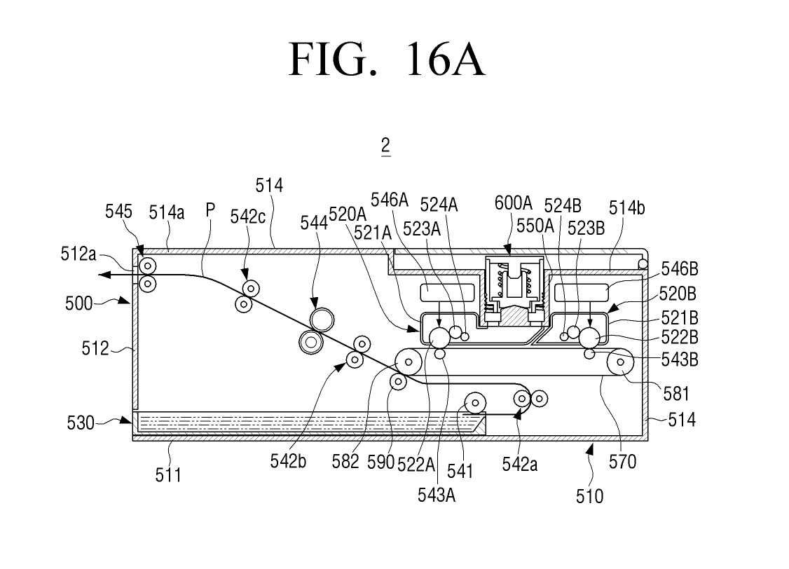

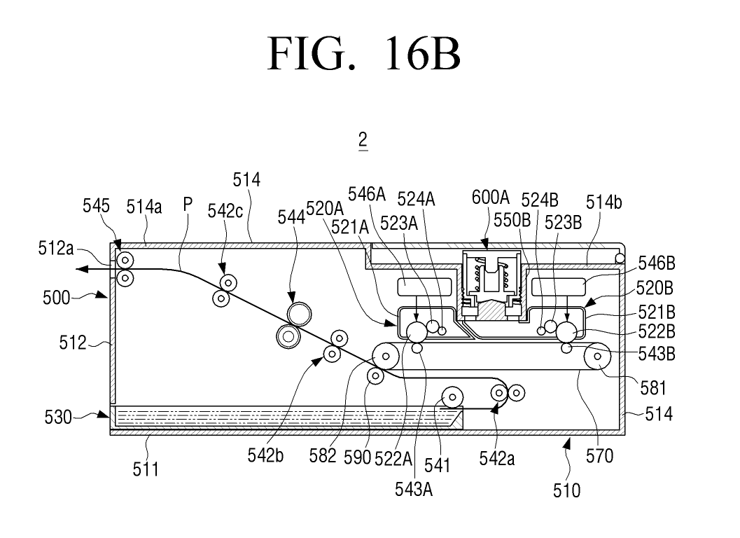

FIG. 16A is a cross-sectional view taken along line III-Ill of FIG. 14. FIG. 16B is a cross-sectional view taken along line IV-IV of FIG. 14.

As illustrated in FIGS. 16A and 16B, the main body 500 may house parts such as first and second developer units 520A and 520B, a pickup unit 541, a plurality of transfer units 542a, 542b, 542c, first and second primary transfer rollers 543A and 543B, a secondary transfer roller 590, a transfer belt 570, a fixing unit 544, a paper discharge unit 545, first and second exposure units 546A and 546B, etc.

The first developer unit 520A is a developer unit corresponding to the first toner container 600A and includes a developer unit casing 521A, and a photosensitive drum 522A, a developer roller 523A, and a supply roller 524A that are housed in the developer unit casing 521A. The second developer unit 520B is a developer unit corresponding to the second toner container 600B and includes a developer unit casing 521B, and a photosensitive drum 522B, a developer roller 523B, and a supply roller 524B that are housed in the developer unit case 521B. The transfer belt 570 is rotatably supported by a driver roller 581 and an idle roller 582.

Parts of the image forming apparatus 2 are disclosed.

A printing process performed by the image forming apparatus 2 according to a paper path P is disclosed. If a printing job starts, electrostatic latent images reflecting image data may be formed on the photosensitive drums 522A and 522B by laser beams provided by the exposure units 546A and 546B. The electrostatic latent images are converted into toner images by the developer rollers 523A and 523B and transferred to the transfer belt 570. A printing paper sheet may be picked up by the pickup unit 541 and passes between the idle roller 582 and the secondary transfer roller 590 so as to secondarily transfer the toner images transferred to the transfer belt 570 onto the printing paper sheet. Thereafter, the printing paper sheet undergoes an image fixing process through the fixing unit 544 and may be discharged outside the main body 500 through the paper discharge hole 512a.

One or more toner container installing parts, e.g., two toner container installing parts 550A and 550B may be formed in the upper housing part 514 of the main body 500.

As illustrated in FIG. 16A, the first toner container installing part 550A has the first toner container installing groove 501A (as illustrated in FIG. 15) and vertically extends from the upper housing 514 into the main body 500. The first toner container installing part 550A may be connected to the developer unit casing 521A of the first developer unit 520A. Therefore, if the first toner container 600A is completely installed in the first toner container installing part 550A, a black color of toner contained in the first toner container 500A may be supplied into the first developer unit 520A through the first toner container installing part 550A.

As illustrated in FIG. 16B, the second toner container installing part 550B has the second toner container installing groove 501B (as illustrated in FIG. 15) and vertically extends from the upper housing 514 into the main body 500. The second toner installing part 550B may be connected to the developer unit casing 521B of the second developer unit 520B. There, if the second toner container 600B is completely installed in the second toner container installing part 550B, a highlight color of toner contained in the second toner container 600B may be supplied into the second developer 520B through the second toner container installing part 550B.

According to an exemplary embodiment, the toner container installing parts 550A and 550B may form a part of the upper housing part 514. Alternatively, the toner container installing parts 550A and 550B may form a part of the developer unit casings 521A and 521B corresponding to the toner container installing parts 550A and 550B.

The foregoing exemplary embodiments and advantages are merely exemplary and are not to be construed as limiting. The present disclosure can be applied to other types of apparatuses. The description of the exemplary embodiments is intended to be illustrative, and not to limit the scope of the claims, and alternatives, modifications, and variations will be apparent to those of ordinary skill in the art.

What is claimed is:

1. An image forming apparatus comprising:
a main body; and
at least one toner container configured to be installed in the main body,
wherein the toner container is installed in a toner container installing groove that is formed to be concave from an upper housing part of the main body.

2. The image forming apparatus of claim 1, wherein the toner container is installed in the toner container installing groove so as to expose at least a portion thereof outside the main body.

3. The image forming apparatus of claim 1, wherein the toner container installing groove vertically extends from the upper housing part downwards.

4. The image forming apparatus of claim 1, wherein the upper housing part of the main body comprises a toner container installing part having the toner container installing groove,
wherein the toner container installing part comprises:
a lower part configured to have at least one toner discharge hole; and
a vertical extending part configured to vertically extend from the lower part toward the upper housing part of the main body.

5. The image forming apparatus of claim 4, wherein the toner container comprises:
a container body configured to comprise at least one toner discharge hole that is formed in the container body; and
a shutter member configured to be installed in the container body so as to be arranged in a first position for closing the toner discharge hole or in a second position for opening the toner discharge hole.

6. The image forming apparatus of claim 5, wherein the shutter member slides between the first and second positions in the container body.

7. The image forming apparatus of claim 6, wherein the toner container further comprises an elastic pressurizing member that elastically pressurizes the shutter member into the first position,
wherein a lower part of the toner container installing part comprises a pressurizing protrusion that pressurizes the shutter member into the second position when installing the toner container.

8. The image forming apparatus of claim 7, wherein the shutter member comprises:
a shutter part configured to have a disc shape and close the toner discharge hole when the shutter member is arranged in the first position;
a support part configured to protrude from an upper surface of the shutter part and support the elastic pressurizing member; and
a pressurized part configured to protrude from a lower surface of the shutter part and pressurize the pressurizing protrusion when installing the toner container.

9. The image forming apparatus of claim 5, wherein the container body is installed in the toner container installing part to bilaterally rotate within a preset angle range, and an arrangement of the shutter member is changed from the first position into the second position by a forward rotation of the container body or is changed from the second position into the first position by a backward rotation of the container body.

10. The image forming apparatus of claim 9, wherein at least one toner discharge hole is formed in a lower part of the container body, and at least one shutter hole is formed in the shutter member and is arranged to correspond to the at least one toner discharge hole in the second position.

11. The image forming apparatus of claim 9, wherein at least one fixing protrusion is formed at the toner container installing part to fix the shutter member, and at least one fixing groove is formed in a lower part of the shutter member so as to insert the fixing protrusion thereinto.

12. The image forming apparatus of claim 11, wherein the fixing protrusion is elastically supported upwards by an elastic support member that is formed in the toner container installing part.

13. The image forming apparatus of claim 9, wherein a screw protrusion is formed at the lower surface of the container body, and a screw hole is formed in the shutter member to be screwed to the screw protrusion.

14. The image forming apparatus of claim 9, wherein at least one rotation protrusion is formed at a side part of the container body, and at least one rotation guide groove is formed in an inner surface of the toner container installing part to guide a rotation of the rotation protrusion.

15. The image forming apparatus of claim 14, wherein at least one vertical guide groove is formed in an inner surface of the vertical extending part to guide the rotation protrusion from the upper housing part to the rotation guide groove when installing the toner container.

16. The image forming apparatus of claim 1, wherein the image forming apparatus comprises a single toner container.

17. The image forming apparatus of claim 1, wherein a toner amount display unit is installed in the upper housing unit of the main body to display a residual amount of toner in the toner container in an analog way and is arranged parallel with the toner container.

18. The image forming apparatus of claim 1, wherein the container has a bottle shape.

19. The image forming apparatus of claim 1, wherein a plurality of the toner containers are installed in the main body and at least two of the plurality of the toner containers are different in size.

20. An image forming apparatus comprising:
a housing part; and
a toner container installing groove that is formed in the housing part.

21. The Image forming apparatus of claim 20, wherein the toner container installing groove is formed to be concave from the housing part.

22. The image forming apparatus of claim 20, wherein a plurality of toner container installing grooves are formed in the housing part, and at least two of the plurality of toner container installing grooves are different in size.

23. A toner container for an image forming apparatus having a housing part, the toner container comprising:
at least one toner discharge hole capable of being opened upon installing the toner container in the image forming apparatus;
a shutter member for opening and closing the toner discharge hole; and
a pressurizing protrusion part for pressurizing the toner container.

24. The toner container of claim 23, wherein a part of the toner container is color-coded to identify a color of toner contained in the toner container.

25. A method for installing a toner container in an image forming apparatus, the method comprising:
inserting the toner container in the image forming apparatus; and
rotating the toner container to open a toner discharge hole.

26. The method of claim 25, wherein the rotating the toner container comprises;
pressurizing a shutter member of the toner container.
